(19) United States
(12) Patent Application Publication
(10) Pub. No.: US 2024/0365807 A1
(43) Pub. Date: Nov. 7, 2024

(54) DEMOULDING APPARATUS AND METHOD

(71) Applicant: Baker Perkins Ltd., Peterborough (GB)

(72) Inventors: Robert Francis, Peterborough (GB); Stuart Hodgkinson, Lincolnshire (GB); Benjamin Hitchborn, Peterborough (GB); Paul Merrison, Peterborough (GB)

(21) Appl. No.: 18/572,256

(22) PCT Filed: Jun. 21, 2022
(86) PCT No.: PCT/GB2022/051578

§ 371 Date: Dec. 20, 2023

(30) Foreign Application Priority Data
Jun. 25, 2021 (GB) 2109217.6

(51) Int. Cl. A23G 3/02; A23G 3/34

(52) U.S. Cl. CPC A23G 3/0284; A23G 3/0038

(57) ABSTRACT

There is herein described a demoulding apparatus and dislodging apparatus for demoulding (i.e. removing) a moulded product with a soft and/or elastic consistency from a cavity in a mould. In particular, there is described a demoulding apparatus and dislodging apparatus for demoulding (i.e. removing) a moulded product with a soft and/or elastic consistency from a cavity in a mould by performing a deformation on the moulded products in cavities via any form of movement, disturbing and/or nudging resulting in the breaking of any adhesion point between the moulded products and the cavities.

### FIELD OF THE INVENTION

The present invention relates to a demoulding apparatus and dislodging apparatus for demoulding (i.e. removing) a moulded product with a soft and/or elastic consistency from a cavity in a mould. In particular, the present invention relates to a demoulding apparatus and dislodging apparatus for demoulding (i.e. removing) a moulded product with a soft and/or elastic consistency from a cavity in a mould by performing a deformation on moulded products in mould cavities via any form of movement, disturbing and/or nudging resulting in the breaking of adhesion between the moulded products and mould cavities and thereby facilitating removal of the moulded products from the mould.

### BACKGROUND OF THE INVENTION

There is a wide range of moulded products such as food and medicinal products which have a soft and elastic consistency which are commonly known as jelly-type products (e.g. jellies). An example of this is confectionary products which comes in various shapes and forms and may include sweets, which are sugary treats usually for children and medicinal products for ingestion to deliver a drug and/or pharmaceutical product. Sweets may be in the form of jellies such as gummies, hard candies, lollipops, toffees and caramels, and fondant and fudge. Medicinal items may be in the form of a jelly form material comprising pharmaceutical products.

Jellies such as gummies are certain types of sweets, which may be striped, layered, full 3D or centre-filled products. Jellies and gummies may be medicated with vitamins, minerals, or other supplements. It is important that these sweeties are manufactured in a hygienic environment.

Traditionally, jellies and gummies were manufactured with starch moulds, however these carried drawbacks such as being unhygienic. Now, jellies and gummies are manufactured in a starch-free environment. Starch free production is the most cost-effective method available for the production of jellies and gummies. The elimination of starch from the manufacturing process significantly reduces production costs and improves hygiene whilst giving the capability of producing a wide range of products.

Jellies and gummies are manufactured in either batch or continuous outputs. The jellies are first weighed, mixed, and cooked in a vessel, usually resulting in a thick syrup. This thick syrup is then transported into a depositor, for depositing into jelly moulds. Different shaped jellies are produced simply by changing the shape of the mould used. A range of mould materials can be used depending on the setting time and ejection properties.

The standard process for moulding and then subsequently demoulding the jellies is a two-step process. First, the moulds are prepared by coating them in an oil or oil-like substance, to aid removing the jellies after setting has taken place. The warm syrup substance is then inserted and poured into cavities in the mould.

Secondly, after the jellies have set in the mould, they are then ejected. This ejection step is currently done in various ways. However, all of the ejection methods in the prior art can be improved, as they are known to damage the jelly on removal, for example, when prodding the jellies out from underneath/through the mould. Another problem with current ejection techniques and methods in the art is that there is a relatively low success rate for ejection, i.e. only around 70-85% of jellies are successfully ejected from the moulds in standard systems in the prior art.

Problems associated with the techniques in the prior art are that the jellies may stick to the mould, resulting in a torn jelly, or a jelly which does not release from the mould at all. The jellies which stick or tear on release from the mould can cause significant problems in the manufacturing process, especially if the process is a continuous one as the jelly mould will need to be cleaned before re-use. This can lead to costly downtimes in the manufacturing process.

Most systems in the prior art require the jelly product to be released and ejected in a single action. For example, an air knife passing over a vertically held mould, or a rotating brush passing over an inverted mould surface. This invariably means the system is not 100% efficient in ejecting the product from the mould cavity, or in the brushing example, the jellies may be damaged.

In other mould types, such as a silicone or plastics mould mat, the mould is inverted and mechanical pins are used to press the product out by deforming the mould and effectively pushing it “inside out”, which releases the product. However, over longer periods the stress on the silicone or plastics will result in structural failure, resulting in a manufacturing part which needs frequent replacement. This is inconvenient for manufacturers leading to additional cost and costly downtimes in the manufacturing process.

Alternatively, metal moulds may be used with either ejector pins or air ports in the bottom of the cavity, such that the mould is inverted and the ejector pin pressed into the mould pushing out the product. Alternatively, air may be used to push the product out. These techniques work well on hard candy where the product is solid and does not deform. However, the technique is less effective on jelly or gummy type products.

Further current methods comprise of inverting the mould and vibrating or striking the mould. This causes mould damage over time. Alternatively, the use of an air knife to blow products out of their cavities may be used. However, this relies on reduced operational speed and unreliable ejection. A third method of brushing products out of the mould causes product damage.

Currently there are no commercial arrangements available to that give reliable 100% ejection at rates of up to, for example, about 12 moulds per minute.

For the above reasons, there remains a need to address or mitigate at least one or more of the aforementioned problems.

It is therefore an object of the present invention to provide an improved method and apparatus for moulding and subsequently demoulding food and/or medicinal products with a soft and elastic consistency (e.g. jelly-like) from a mould.

It is further object of the present invention to provide an improved method and apparatus for removing (i.e. demoulding) food and/or medicinal products with a soft and elastic consistency (e.g. jelly-like) from a mould.

### SUMMARY OF THE INVENTION

According to a first aspect of the present invention there is provided a dislodging apparatus for deforming a moulded product with a soft and elastic consistency within a mould cavity in a production process, the dislodging apparatus comprising:
a prodder which is capable of deforming the moulded product which is held within the mould cavity in a mould;
wherein on deformation the moulded product is deformed such that adhesion of the moulded product to the mould cavity is removed or substantially removed;
thereby preparing the moulded product to be ejected and/or removed from the mould.

The present invention relates to a demoulding apparatus and a dislodging apparatus for demoulding (i.e. removing) a moulded product with a soft and/or elastic consistency from a cavity in a mould.

The mould may be a simple mould i.e. has no moving parts. The mould may be formed from one material, and comprise no discontinuities. The mould may comprise simple cavities which are filled and emptied from above. The mould may be made with a solid base, meaning that the product needs to be removed from the cavity via the top of the mould.

The product may be a moulded confectionary product.

The product may have a lower surface which is in contact with the mould, and an upper surface which is not in contact with the mould. The upper surface may be parallel to the top of the mould.

The prodding may deform the product on the upper surface only. The prodding on the upper surface may deform the whole product.

In particular, the present invention relates to an improved process for demoulding (i.e. removing) a moulded product with a soft and/or elastic consistency from a cavity in a mould which may have a removal and/or ejection efficiency for the moulded products of greater than about 95%, greater than about 99% and more typically greater than about 99.5%.

The prodder may be any contact or non-contact device, which is capable of disturbing and/or nudging the moulded product in a non-damaging way. For example, the prodder may be a pneumatic air flow (e.g. non-contact), which is strong enough to separate the moulded product from the mould cavity and the mould. The prodder may also be any shaped mechanical device which deforms the moulded product. This may be via a deformation by prodding and/or nudging in a substantially vertical plane, a substantially horizontal plane, or any plane in-between.

Prodding should be interpreted as any movement, disturbing and/or nudging from the prodder which deforms the moulded product by an amount which allows the moulded product to break adhesion to the cavity in the mould. This process may occur at multiple moulded products on the mould simultaneously or sequentially.

In preferred embodiments, the prodding action may occur at an offset position from a central substantially vertical axis of the moulded product. By having the prodding action offset from the substantially central vertical axis has been found to be the most effective method at separating any contact points between the moulded product and the mould. A similar approach may also be preferred in a non-symmetrical shape for a moulded product, such as a bear paw.

The moulded product may therefore comprise a centreline vertical axis, running substantially vertically through the moulded product, and wherein the prodder may prod the moulded product at a location offset from the centreline axis.

Also, it may be preferred that the concentrated blast or flow of gas/air may be offset from a central vertical axis of the moulded product in the cavity.

The objective of the prodder may be seen as to ensure there is a low-friction gliding film between the moulded product and the mould cavity which greatly facilitates the removal of the moulded product.

It is preferred that there is formed a continuous or substantially continuous lubricant film between the moulded product and the cavity.

Typically, the non-contact prodder may comprise a pneumatic prodder which may use a concentrated blast or flow of gas/air to disturb, nudge and/or deform the moulded product in the cavities. The pneumatic prodder may provide a deformation on the moulded products in the cavities in the moulds via any form of movement, disturbing and/or nudging resulting in the breaking of any adhesion point between the moulded products and the cavities.

Alternatively, the prodder may be a contact prodder such as a mechanical prodding device, or a mechanical linear prodder, which may move in a linear fashion to deform the moulded product or a plurality of moulded products in mould cavities.

In further embodiments, the mechanical prodding device may be a mechanical device, which is effectively a blunt object which moves in a substantially vertical up and down direction to make contact with and prod and/or nudge the moulded product. During the prodding and/or nudging process, the moulded product may be deformed elastically, which results in the moulded product changing shape temporarily within the cavity, before returning to its original shape.

Alternatively, the prodding action may occur in a substantially angled direction to make contact with and prod and/or nudge and/or displace the moulded product according to any of the following: about 20-80 degrees from the vertical; about 30-70 degrees the vertical or about 60 degrees from the vertical.

The prodding action may therefore have a translational movement and swipe across the upper surface of the moulded product.

The prodding action may therefore be in the form of a swiping and/or scooping action on the moulded product. The prodding action may therefore be in the form of an actuation through an arc.

It has been found that the resulting deformation of the moulded product is sufficient to disturb the contact point(s) between the moulded product and the cavity in the mould, without damaging the moulded product, and without significantly moving the moulded product. The resulting deformation may therefore result in the lubricant film fully enclosing (or substantially fully enclosing) the moulded product inside the cavity. This therefore results in a low-friction gliding film between the moulded product and the cavity which greatly facilitates the removal of the moulded product.

In particular embodiments, the mechanical prodding device may be a mechanical rotary prodder, which may move in a rotary fashion to deform the moulded product or a plurality of moulded products.

The prodder may be capable of deforming one or a plurality of moulded products, simultaneously or sequentially.

The prodder may comprise a tip intended to contact the moulded product which is generally blunt, to avoid damaging the moulded product during contact.

The prodder may be capable of deforming and/or disturbing the moulded product in an elastic manner, thereby allowing the moulded product to return to its original shape after the prodding.

The moulded product may be a jelly-type product which has a soft and/or elastic consistency.

The moulded product may be any semi-solid somewhat elastic mass. In particular, the moulded product may be any type of confectionary e.g. jam, savoury produce, or any gelatine/pectin type substance.

The moulded product may also be a medicinal product.

The moulded product may be any suitable shape.

The moulded product may comprise a substantially flat upper surface which is substantially parallel to the top of the mould, as is created in a setting process.

During the setting process a portion, usually a bottom surface, of the moulded product may become stuck (i.e. adhered) to a lower portion of the surface of the cavity in the mould.

Typically, a portion of the moulded product may comprise a layer of lubricating fluid between the moulded product and the cavity of the mould. Prior to prodding there is a portion which does not have any lubricating fluid between the moulded product and the cavity of the mould.

Each mould may comprise a plurality of cavities.

There may be a plurality of moulded products held within a plurality of mould cavities.

Each of the moulds may comprise a plurality of cavities within which a plurality of moulded products may be formed and/or set.

The moulds may be formed from any suitable plastics, composite or metal/alloy.

The moulded products may be any suitable size and may, for example, have a maximum cross-sectional diameter of anywhere between: about 0.2-2 cm; about 0.2-1 cm; or about 0.2-0.5 cm.

The moulded products may be any suitable size and may, for example, have a maximum depth of anywhere between: about 0.2-2 cm; about 0.2-1 cm; or about 0.2-0.5 cm.

The process of forming the moulded product may comprise pouring a liquid-like material (e.g. a hot syrup) into the cavities in the mould. In preferred embodiments, the cavities may also be pre-coated with a low friction substance such as an oil or PTFE such as Teflon (registered trade mark), to reduce the likelihood of the moulded product adhering and/or sticking to the cavities of the mould. The low friction substance is intended to facilitate the removal of the moulded product from the mould. The liquid-like material (e.g. jelly syrup) may then be deposited into the mould and allowed to set for a time such as between about 5 to 60 minutes. After the liquid-like material (e.g. jelly syrup) has set into the cavities in the mould, the moulded products may then be removed and/or ejected.

In preferred embodiments, a lubricant film may therefore be deposited into cavities in the mould. The lubricant film may therefore be located between the moulded product and the walls of the cavity before the liquid-like material (e.g. jelly syrup) is poured.

It has however been found that after the liquid-like material (e.g. jelly syrup) has been setting in the cavity for a short time, the formed moulded product may displace the lubricant film at, for example, the bottom of the cavity, resulting in at least one or a plurality of moulded product contact points with the cavity. The contact point(s) may be the only location where there is a not a low friction lubricant film separating the moulded product from the cavity of the mould. This results in an adhesive contact region at the contact point(s). This contact can prevent the moulded product from easily exiting the mould.

According to a second aspect of the present invention there is provided a demoulding apparatus for removing a moulded product with a soft and elastic consistency from a mould cavity, the demoulding apparatus comprising:
a conveyor system for moving at least one or a plurality of moulds along the demoulding apparatus;
a dislodging apparatus for deforming a moulded product with a soft and elastic consistency within a mould cavity in the mould; and
an ejection device capable of removing the moulded product from the mould cavity in mould.

The demoulding apparatus may operate in a continuous or semi-continuous manner.

The dislodging apparatus may be as defined in the first aspect.

The dislodging apparatus may comprise a rotary mechanical prodder along with optionally a pneumatic air knife.

The demoulding apparatus may also comprise a vacuum pickup to remove dislodged moulded products.

Furthermore, the demoulding apparatus may also comprise a scraper/knife to aid with the removal of the dislodged moulded products.

The demoulding apparatus may also comprise a conveyor in the form of a conveying belt allowing a continuous process to occur.

During use, a plurality of moulds may be conveyed along the conveyor.

The demoulding apparatus may further comprise a device which applies a lubricating fluid to mould cavities prior to liquid-like material (e.g. jelly syrup) being poured into the cavities. The device which deposits the lubricating fluid may be located on a depositing machine prior to the demoulding process.

The ejection device may be a pneumatic gas knife, which removes the moulded product from the cavity of the mould via a high velocity jet of gas and/or air e.g. a curtain of gas and/or air.

The high velocity jet of gas and/or air may be in the form of a concentrated blast or flow of gas/air. The high velocity jet of gas may be in a controlled profile and/or shape such as a circular cone or jet.

The ejection device may be a vacuum device, which removes the moulded product from the cavity of the mould via suction.

There may be a plurality of moulded products held within a plurality of mould cavities.

The demoulding apparatus may operate at a rate of processing of any of the following: about 5 moulds/min-50 moulds/min; about 5 moulds/min-25 moulds/min; or about 12 moulds/min. For example, this may equate to: about a 1-20 second cycle time for each mould; about a 1-10 second cycle time for each mould; or about a 5 second cycle time for each mould.

The number of moulded products (e.g. jellies) in each mould may range from any of the following: about 10-10,000; about 10-1,000; about 20-500; about 100-500; or about 352.

The number of moulded products which may be processed per minute may be any of the following: about 100-100,000; about 100-10,000; about 1,000-10,000; or about 5,000.

The demoulding apparatus may comprise a plurality of dislodging apparatus located in series.

According to a third aspect of the present invention there is provided a method of forming a moulded product with a soft and elastic consistency, the method comprising the steps of:
providing a mould for the moulded product;
inserting a liquid-like material into a mould cavity in the mould where it remains until set thereby forming the moulded product;
prodding the moulded product to deform the moulded product within the mould cavity such that adhesion of the at least one moulded product to the mould cavity is removed or substantially removed; and
ejecting and/or removing the moulded product from the mould.

The product in any of the aspects may be a moulded confectionary product.

The product in any of the aspects described before or hereinafter, may have a lower surface which is in contact with the mould, and an upper surface which is not in contact with the mould. The upper surface may be parallel to the top of the mould. The upper surface may be in contact with the air above the mould. The upper surface may be defined as the surface of the product which is in direct contact with only the air above the mould.

The upper surface of the product may be generally flat, as the upper surface may be formed via gravitational forces which set the product. The upper surface of the product may be generally parallel with the upper surface of the mould.

The prodding in any of the aspects may deform the product on the upper surface only. The prodding may only directly prod the upper surface of the mould.

The prodding may deform and/or disturb the moulded product thereby breaking mechanical adhesion to the cavity and the mould.

The prodding of the moulded product may be performed using contact means such as a prodding arm.

Alternatively, the prodding of the moulded product may be performed using non-contact means such as a high velocity pneumatic jet.

The moulded product may be prodded using a dislodging apparatus as defined in the first aspect.

The method may further comprise a step of pre-coating the mould in a lubricating fluid.

The moulded product may be formed on a production line which operates in a continuous or semi-continuous manner. This may allow a high-speed production process to occur.

According to a further aspect of the present invention, there is provided a method of dislodging a moulded confectionary product with a soft and elastic consistency, the product being within a mould cavity in a production process, the product having a lower surface which is in contact with the mould, and an upper surface which is not in contact with the mould, the method comprising the steps of: using a prodder to deform the moulded confectionary product on the upper surface, the moulded confectionary product being held within the mould cavity, whereby on deformation, the moulded confectionary product is deformed such that adhesion of the moulded confectionary product to the mould cavity is removed or substantially removed, wherein the moulded confectionary product remains substantially within the cavity after deformation; and then ejecting the moulded confectionary product from the mould cavity.

According to a further aspect of the present invention, there is provided a method of forming a moulded confectionary product with a soft and elastic consistency, the method comprising the steps of: providing a mould for the moulded confectionary product; inserting a liquid-like material into a mould cavity in the mould where it remains until set thereby forming the moulded confectionary product, the product having a lower surface which is in contact with the mould, and an upper surface which is not in contact with the mould; prodding the moulded confectionary product on the upper surface, to deform the moulded confectionary product within the mould cavity such that adhesion of the moulded confectionary product to the mould cavity is removed or substantially removed, wherein the moulded confectionary product remains substantially within the cavity after deformation; and then ejecting and/or removing the moulded confectionary product from the mould.

According to a further aspect of the present invention, there is provided a dislodging apparatus for deforming a moulded confectionary product with a soft and elastic consistency within a mould cavity in a production process, the product having a lower surface which is in contact with the mould, and an upper surface which is not in contact with the mould, the dislodging apparatus comprising: a moulded confectionary product within a mould cavity, a prodder which is capable of deforming the moulded confectionary product, via the upper surface of the product, the product being held within the mould cavity in a mould; wherein on deformation the moulded confectionary product is deformed such that adhesion of the moulded confectionary product to the mould cavity is removed or substantially removed, the moulded confectionary product remaining substantially within the cavity after deformation; thereby preparing the moulded confectionary product to be ejected and/or removed from the mould.

According to a further aspect of the present invention, there is provided a demoulding apparatus for removing a moulded confectionary product with a soft and elastic consistency from a mould cavity, the product having a lower surface which is in contact with the mould, and an upper surface which is not in contact with the mould, the demoulding apparatus comprising:
a moulded confectionary product within a mould cavity, a conveyor system for moving at least one or a plurality of moulds along the demoulding apparatus; a dislodging apparatus for deforming a moulded confectionary product on the upper surface, the product having a soft and elastic consistency within a mould cavity in the at least one or the plurality of moulds wherein the moulded confectionary product remains substantially within the cavity after deformation; and an ejection device capable of removing the moulded confectionary product from the mould cavity in the at least one or the plurality of moulds.

Any of the above further aspects of the invention may be combined with any of the features presented as optional above.

### BRIEF DESCRIPTION OF THE DRAWINGS

Embodiments of the present invention will now be described, by way of example only, with reference to the following Figures:

FIG. 1 is an example of a typical mould according to the prior art in which moulded products are made, showing some finished hemisphere moulded products (e.g. jellies) both inside and outside the mould;

FIG. 2 is an example of a further mould according to the prior art in which there are a large number of moulded products (e.g. jellies) situated in the mould;

FIG. 3 is a view of the mould shown in FIG. 2 with one ‘bear paw’ shaped moulded product (e.g. jelly) removed from the mould;

FIG. 4 is a sectional side view of a moulded product (e.g. jelly) stuck to the bottom of a mould;

FIG. 5 is a sectional side view of the moulded product (e.g. jelly) shown in FIG. 4 being dislodged from the mould according to an embodiment of the present invention;

FIG. 6 is a representation of a demoulding apparatus according to an embodiment of the present invention, comprising a dislodging apparatus in the form of a prodder along with a vacuum pickup and scraper/air knife;

FIG. 7 is a representation of a demoulding apparatus according to an embodiment of the present invention, comprising a dislodging apparatus which comprises a pneumatic prodder along with a pneumatic air knife;

FIG. 8 is a representation of a demoulding apparatus according to an embodiment of the present invention comprising a dislodging apparatus which comprises a rotary mechanical prodder along with a pneumatic air knife;

FIG. 9 is a representation of a demoulding apparatus according to an embodiment of the present invention comprising a dislodging apparatus which comprises a linear mechanical prodder along with an air knife; and

FIG. 10 is a representation of a demoulding apparatus according to an embodiment of the present invention, comprising a dislodging apparatus which comprises a linear mechanical prodder along with a vacuum demoulder removal unit.

### DETAILED DESCRIPTION

Generally speaking, the present invention relates to a demoulding apparatus and a dislodging apparatus for demoulding (i.e. removing) a moulded product (e.g. jelly) with a soft and/or elastic consistency from a cavity in a mould.

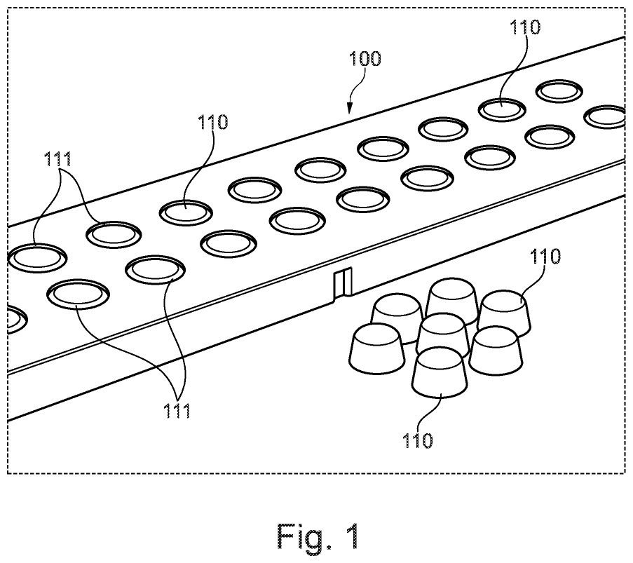

FIG. 1 is an example of a typical mould 100 in which moulded products 110 (e.g. jellies) are made. The mould 100 comprises a series of mould cavities 111 within which jellies 110 are formed.

FIG. 1 shows some finished hemisphere moulded products 110 both inside and outside the mould 100. The mould 100 shown may be made of any suitable material such as any suitable plastics, composite or metal/alloy.

Moulded products such as jellies 110 are generally all created in the same way. A hot syrup containing the necessary ingredients is prepared and then deposited into the mould 100 as shown in FIG. 1. Since the moulds 100 are reusable, they are often prepared before the moulded product syrup (e.g. jelly syrup) is deposited into them. Preparation is usually done by coating cavities of the moulds 100 with a low friction substance such as an oil or PTFE (e.g. Teflon, registered trade mark), to reduce the likelihood of the moulded product sticking to the mould 100. The low friction substance is intended to facilitate the removal of the moulded product 110 from the mould 100.

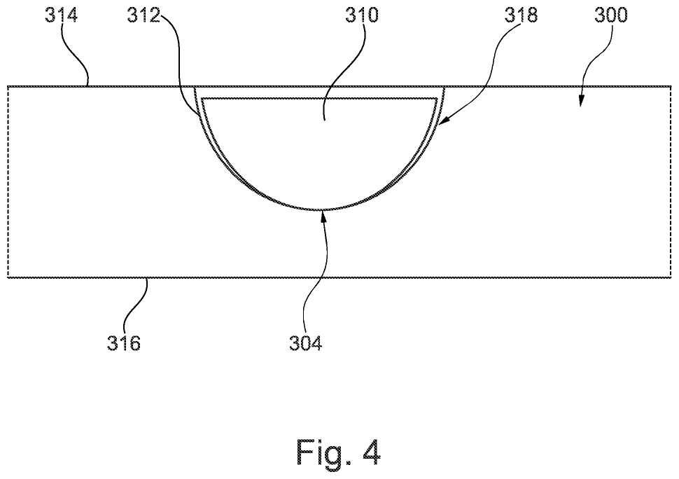

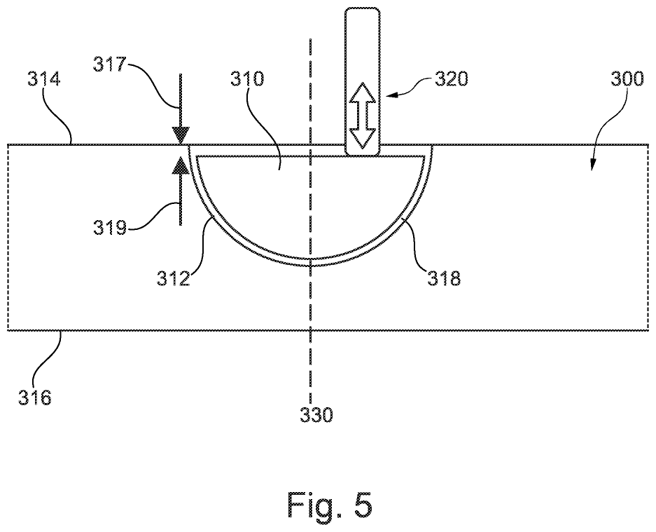

The moulded product syrup (e.g. jelly syrup) is deposited into the mould 100 and allowed to set for a time such as between about 5 to 60 minutes. After the moulded product syrup (e.g. jelly syrup) has set in the cavities 111 of the mould 100, the moulded products 110 are then usually removed or ejected, with varying degrees of success. The moulded products 110 can often stick to the cavities 111 in the moulds 100. This can cause the moulded products (e.g. jellies 110) to tear or be damaged on exit, or to remain stuck and adhered in the cavities 111 of the mould 100. These issues will be explained in more detail below and in particular in reference to FIGS. 4 and 5.

The invention seeks to add another method step before the ejection process, to increase the efficiency of the removal of the moulded products (e.g. jellies) from the moulds. The demoulding apparatus may have a removal and/or ejection efficiency for the moulded products of greater than greater than about 90%, greater than about 99% and more typically greater than about 99.5%.

The mould 100 in FIG. 1 is shown to hold two rows of moulded products (e.g. jellies) 110, and may hold around, for example, 30 moulded products (e.g. jellies) in total. The moulded products 110 shown in FIG. 1 are generally hemispherical in shape. The hemispheres are created by filling the cavities 111 in the mould 100 with the hot moulded product syrup (e.g. jelly syrup). The hot syrup fills the cavities 111 in the mould 100, and when setting, creates a substantially horizontal flat upper surface on the top of the moulded product 110 via gravitational forces. The moulded products 110 are then ejected, and when turned upside-down as shown in FIG. 1, sit on a flat surface.

Although the invention will be described in relation to moulded products such as jellies/jelly, this should be construed to be a generic term for any semi-solid somewhat elastic mass. In particular, the moulded products can be any type of confectionary as previously described, jam, savoury produce, or any gelatine/pectin type substance. Moreover, the moulded products can be medicinal products for ingestion to deliver a drug and/or pharmaceutical product.

The moulded products 110 may therefore be any suitable type of moulded product which has a soft and/or elastic consistency.

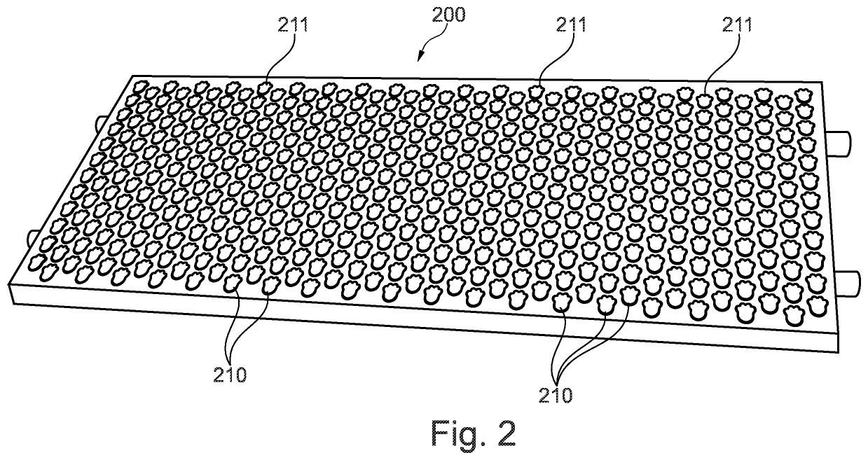

FIG. 2 is an example of a further mould 200 in which there are a large number of moulded products 210 situated in cavities 211 in the mould 200. The moulded products 210 shown in FIG. 2 are ‘bear paw’ shaped but still comprise the substantially flat upper surface created by gravitational forces in the setting process.

The moulded products of the present application should not be limited to any particular shape, and the moulded products shown in FIGS. 1 and 2 are given as mere examples. Most moulded products will comprise a substantially flat upper surface which is substantially parallel to the top of the mould 100, as is created in the setting process.

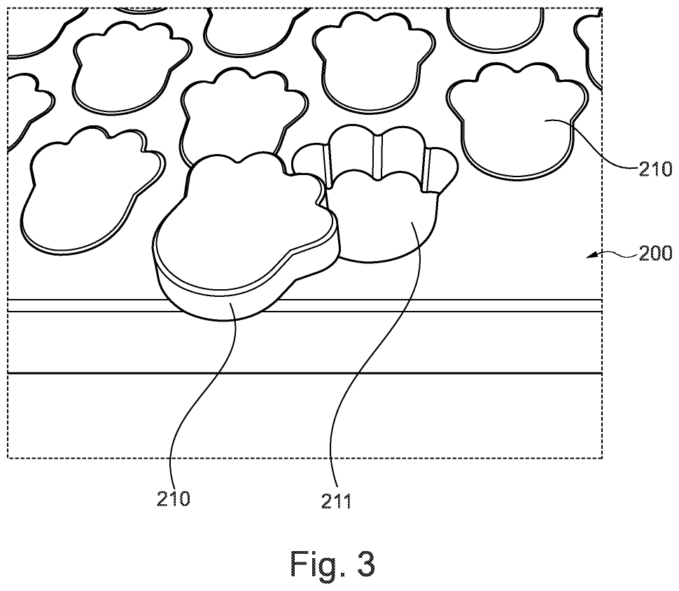

FIG. 3 is an expanded view of the mould 200 shown in FIG. 2 with one of the ‘bear paw’ shaped moulded products 210 removed from one of the cavities 211 in the mould 200. The shape of the moulded product 210 and the cavity 211 which it came from can clearly be seen. As can be envisaged, the moulded products 210 are a tight fit inside the cavities 211, and therefore can be difficult to remove.

FIG. 4 is a sectional side view of a moulded product (e.g. jelly) 310 stuck inside a cavity 312 on a mould 300. As shown in FIG. 4, the cavity 312 is substantially hemispherical in shape. In particular, the moulded product 310 is stuck (i.e. adhered) to a contact point 304 on the bottom surface of the cavity 312. In other embodiments, the moulded product may be stuck (i.e. adhered) to any one of or a plurality of contact points on the surface of the cavity 312.

The mould 300 is shown with a top surface 314 and a bottom surface 316. The top surface 314 comprises the cavities 312 which are to be filled with the moulded product syrup (e.g. jelly syrup). It is the shape of the cavities 312 which defines the size and shape of the finished moulded product 310.

Only one cavity 312 is shown in FIG. 4. However, this is just one of the many cavities which may be in one set of moulds 300. The cavity 312 shown in FIG. 4 is hemispherical in shape, however the cavity 312 may be any shape. The upper surface of the jelly 310 is shown to be parallel to the top surface 314 of the mould 300, resulting in a flat surface on the jelly 310. This flat surface is created by the self-levelling effect of gravity.

FIG. 4 specifically shows a moulded product 310 after it has been deposited into the cavity 312 in the mould 300. A lubricant film 318 can be seen at the sides of the hemisphere of the cavity 312. As shown in FIG. 4, the lubricant film 318 is located between the moulded product 310 and the cavity 312 wall. In practice, the lubricant film 318 is applied to the walls of the cavity 312 before the moulded product syrup (e.g. jelly syrup) is deposited. The lubricant film may be any suitable low friction substance.

Through research, it was found that the lubricant film 318 can be evenly dispersed throughout the walls of the cavity 312 before the jelly liquid is poured. However, after the moulded product 310 has been setting in the cavity 312 for a short time, the moulded product 310 displaces the lubricant film 318 at, for example, the bottom of the cavity 312, resulting in a moulded product to mould contact point 304 with the cavity 312. There may be more than one and a plurality of moulded product to mould contact points. The contact points such as contact point 304 is/are the only locations where there is a not a low friction lubricant film 318 separating the moulded product 310 from the cavity 312 of the mould 100. This results in an adhesive contact region at the contact point 304. This contact point 304 can prevent the moulded products 310 from easily exiting the mould 300.

This moulded product to mould contact point 304 has been found to be the direct cause of many issues when removing and/or ejecting the moulded product 310 from the mould 300. This fact is not known in the art, and was the result of extensive experimentation and research.

The contact point 304 leads manufacturers to use over-zealous methods to remove the moulded products 310 from the moulds 300, which results in damaged moulded products 310 or partially removed moulded products 310. Techniques in the art such as using brushes to remove the moulded products 310 can also damage them. An air knife can be used at high air velocities to ensure the removal of the moulded products 310, however the high velocity of the air can damage the moulded products 310 and air knives are not the most efficient in product ejection.

FIG. 5 is a sectional side view of the moulded product 310 shown in FIG. 4 being dislodged from the mould 300 according to an embodiment of the present invention.

FIG. 5 therefore shows an apparatus and method for dislodging the moulded product 312 from the moulded product to mould contact point 304 shown in FIG. 4. FIG. 5 also shows that there is a freeboard area between the upper surface of the moulded product 312 and the top surface 314 of the mould 300 shown between arrows 317, 319. The freeboard area may, for example, have a minimal size of about 1.0 mm.

In FIG. 5, there is shown a prodder 320. The prodder 320 may in some instances be called a dibber. After the moulded product 310 has set in the cavity 312 of the mould 300 and before the moulded product 310 is removed (e.g. ejected) from the mould 300, the moulded product 310 is prodded by the prodder 320.

The prodder 320 shown in FIG. 5 is a mechanical device, which is effectively a blunt object which moves in a substantially vertical up and down direction to make contact with and prod and/or nudge and/or displace the moulded product 310.

Alternatively, the prodding action may occur in a substantially angled direction to make contact with and prod and/or nudge and/or displace the moulded product 310 according to any of the following: about 20-80 degrees from the vertical; about 30-70 degrees the vertical or about 60 degrees from the vertical. The prodding action may therefore have a translational movement and swipe across the upper surface of the moulded product 310. The prodding action may therefore be in the form of a swiping and/or scooping action on the moulded product 310. The prodding action may be in the form of an actuation through an arc.

During the prodding and/or nudging and/or displacement process, the moulded product 310 is deformed elastically, which results in the moulded product 310 changing shape temporarily within the cavity 312, before returning to its original shape.

The resulting deformation of the moulded product 310 is enough to disturb any contact point between the moulded product 310 and the cavity 312 such as the contact point 304, shown in FIG. 4, between the moulded product 310 and the cavity 312, without damaging the moulded product 310, and without significantly moving the moulded product 312.

As shown in FIG. 5, there is no longer a contact point 304 between the moulded product 310 and the cavity 312 and the mould 300. The lubricant film 318 fully encloses (or substantially fully encloses) the moulded product 310 inside the cavity 312. This therefore results in a low-friction gliding film between the moulded product 310 and the cavity 312 which greatly facilitates the removal and/or ejection of the moulded product 310.

The prodder 320 is shown as a mechanical prodding device in FIG. 5, however this should not be construed to be limiting. The prodder of the present application may be any contact or non-contact device, which is capable of disturbing and/or nudging and/or displacing the moulded product in a non-damaging way. For example, the prodder may be a pneumatic air flow (non-contact), which is strong enough to separate the moulded product and any contact point from the cavity and the mould.

The prodder may also be any shaped mechanical device which deforms the moulded product. This may be via a deformation by prodding and/or nudging in the substantially vertical plane, the substantially horizontal plane, or any plane in-between. Prodding should be interpreted as any movement, disturbing and/or nudging from the prodder which deforms the moulded product by an amount allowing the moulded product to break free from any form of adhesion to the cavity in the mould.

It should be noted that in FIG. 5, the prodder 320 is also shown to be offset from a central axis 330 of the moulded product 310. Locating the prodder 320 offset from the central axis 330 was proven to be most effective at separating the contact point 304 between the moulded product 310 and the mould 300. A similar approach may be the most effective in a non-symmetrical shape, such as a bear paw. The objective of the prodder 320 is to ensure the lubricant film 318 prevents any sticking points between the moulded product 310 and the cavity 312 in the mould 100.

It is preferred that the prodder 320 provides a deformation on the jelly 320 via any form of movement, disturbing and/or nudging resulting in the breaking of any adhesion point between the moulded product 310 and the cavity 312. It is preferred that there is formed a continuous or substantially continuous lubricant film 318 between the moulded product 310 and the cavity 312.

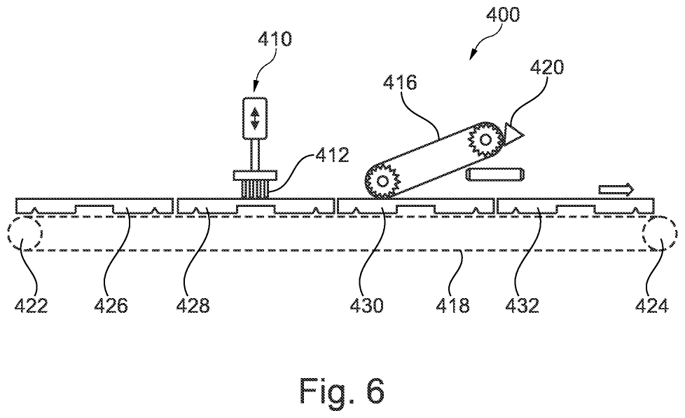

FIG. 6 is a representation of a demoulding apparatus 400 according to an embodiment of the present invention. The demoulding apparatus 400 comprises a dislodging apparatus 410 in the form of a mechanical prodder 412, a vacuum pickup 416, a conveyor 418 and scraper/air knife 420.

FIG. 6 also shows that the conveyor 418 extends between two rollers 422, 424 allowing the process to be continuous. Located on the conveyor 418 there is a series of moulds 426, 428, 430, 432. On the upper surface of the moulds 426, 428, 430, 432 there is a series of moulded products in cavities on the moulds 426, 428, 430, 432, as previously described.

As shown in FIG. 6, the mould 428 with moulded products set in the cavities is then passed under the dislodging apparatus 410. The dislodging apparatus 410 houses the prodder 412.

The prodder 412 provides a deformation on the moulded products in cavities in the mould 428 via any form of movement, disturbing and/or nudging resulting in the breaking of any adhesion point between the moulded products and the cavities. It is preferred that there is formed a continuous or substantially continuous lubricant film between the moulded products and the cavity.

The prodding may occur in a substantially vertical up-and-down manner. Alternatively, the prodding may occur in a direction according to any of the following: about 20-80 degrees from the vertical; about 30-70 degrees the vertical or about 60 degrees from the vertical. The prodding may therefore function as a swiping and/or scooping action on the moulded product. The prodding action may be in the form of an actuation through an arc.

The prodder 412 as shown in FIG. 6 comprises a plurality of prodding elements allowing a fast and continuous process to occur.

After the moulded products have been prodded, they are passed on to the vacuum pickup 416 where the moulded products are then subjected to the scraper/air knife 420, which removes them from the conveyor 416 using, for example, a concentrated high-pressure curtain of air. The removed moulded products are then passed onto a product discharge area.

The moulding apparatus 400 shown in FIG. 6 may operate at a rate of processing of any of the following: about 5 moulds/min-50 moulds/min; about 5 moulds/min-25 moulds/min; or about 12 moulds/min. For example, this may equate to: about a 1-20 second cycle time for each mould; about a 1-10 second cycle time for each mould; or about a 5 second cycle time for each mould.

The number of moulded products (e.g. jellies) in each mould 426, 428, 430, 432 may range from any of the following: about 10-10,000; about 10-1,000; about 20-500; about 100-500; or about 352.

The number of moulded products which may be processed per minute may be any of the following: about 100-100,000; about 100-10,000; about 1,000-10,000; or about 5,000.

The demoulding apparatus 400 may have an ejection efficiency for the moulded products of greater than about 95%, greater than about 99% and more typically greater than about 99.5%.

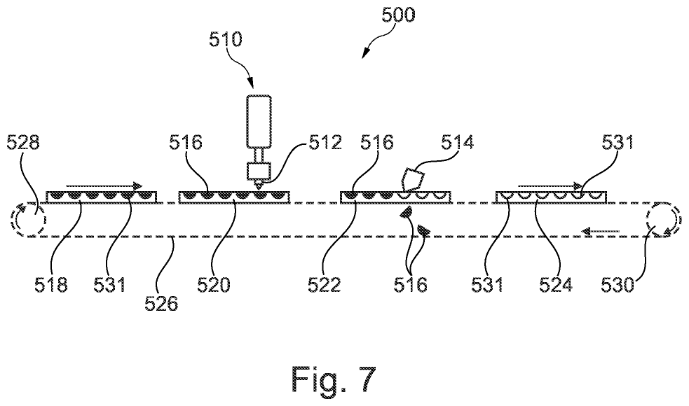

FIG. 7 is a representation of a further demoulding apparatus 500 according to an embodiment of the present invention. The demoulding apparatus 500 comprises a dislodging apparatus 510 which comprises a pneumatic prodder 512 along with a pneumatic air knife 514 for removing moulded products 516 from the moulds 518, 520, 522, 524.

The demoulding apparatus 500 also comprises a conveyor 526 extending between two rollers 528, 530. The conveyor 526 moves the moulds 518, 520, 522, 524 from left to right.

The dislodging apparatus 510 in FIG. 7 comprises a pneumatic prodder 512, which uses a concentrated blast or flow of gas/air to disturb, nudge and/or deform the moulded products 516 in the cavities 531. The concentrated blast or flow of gas/air may be in a controlled profile and/or shape such as a circular cone or jet. Similar to before, the pneumatic prodder 512 provides a deformation on the moulded products 516 in cavities 531 in the moulds 518, 520, 522, 524 via any form of movement, disturbing and/or nudging resulting in the breaking of any adhesion point between the moulded products 516 and the cavities 531. It is preferred that there is formed a continuous or substantially continuous lubricant film between the moulded products 516 and the cavity 530.

Also, it may be preferred that the concentrated blast or flow of gas/air may be offset from a central the vertical axis of the moulded product 516.

The concentrated blast or flow of gas/air may occur in a direction according to any of the following: about 20-80 degrees from the vertical; about 30-70 degrees the vertical or about 60 degrees from the vertical. The concentrated blast or flow of glass/air may therefore function as a swiping and/or scooping action on the moulded product 516. The prodding action may be in the form of an actuation through an arc.

The concentrated blast or flow of gas/air therefore breaks any form of connection or adhesion point between the moulded products 516 and the cavities 530 in the moulds 518, 520, 522, 524. The air knife 514 then has a much higher success rate of removing the moulded products 516 from the moulds 518, 520, 522, 524. This has been found to result in an improved efficiency rate for removing the moulded products 516 of, for example, such as greater than about 95%, greater than 99% or more typically greater than about 99.5%. The moulded products 516 can be seen falling from the mould 522, underneath the air knife 514.

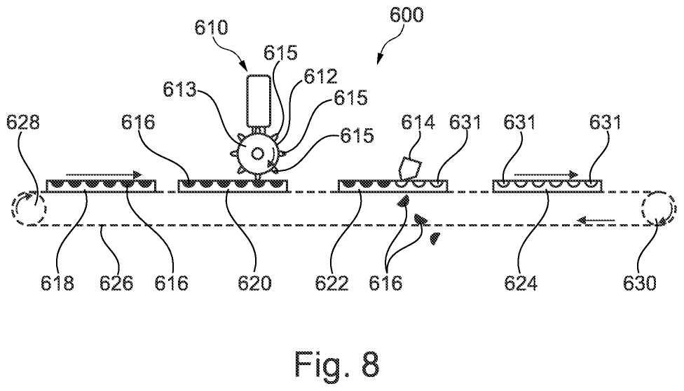

Another embodiment is shown in FIG. 8, where the demoulding apparatus 600 comprises a dislodging apparatus 610 which comprises a rotary mechanical prodder 612.

The demoulding apparatus 600 also comprises a pneumatic air knife 614 for removing moulded products 616 from the moulds 618, 620, 622, 624. The demoulding apparatus 600 also comprises a conveyor 626 extending between two rollers 628, 630. The conveyor 626 moves the moulds 618, 620, 622, 624 from left to right.

The rotary mechanical prodder 612 is the only difference between this embodiment and the embodiment shown in FIG. 7. The rotary mechanical prodder 612 is another example of a contact dislodging apparatus 610.

FIG. 8 shows that the rotary mechanical prodder 612 comprises a rotary wheel 613 which typically rotates in sequence and in time with the conveyor 626, to enable the prodding to take place in a pre-defined location on the moulded products 616. Located on the outside surface of the rotary wheel 613 there is a plurality of prodders 615.

The benefit of a rotary prodder 612 is that there are fewer ‘prods-per-prodder’ (i.e. no linear actuations) when compared to the embodiment in FIG. 6. There may also be less mechanical stress on the components, resulting in a component which is useful for long-term continuous processes such as in high-speed demoulding processes.

Similar to before, the rotary prodder 612 provides a deformation on the moulded products 616 in cavities in the moulds 618, 620, 622, 624 via any form of movement, disturbing and/or nudging resulting in the breaking of any adhesion point between the moulded products and the cavities 631. It is preferred that there is formed a continuous or substantially continuous lubricant film between the moulded products 616 and the cavity 631.

Also, it may be preferred that the prodding action from the prodders 615 is offset from a central vertical axis of the moulded products 616. The prodding breaks any form of connection or adhesion point between the moulded products 616 and the cavities 631 in the moulds 618, 620, 622, 624. The moulded products 616 can be seen falling from the mould 622, underneath the air knife 614.

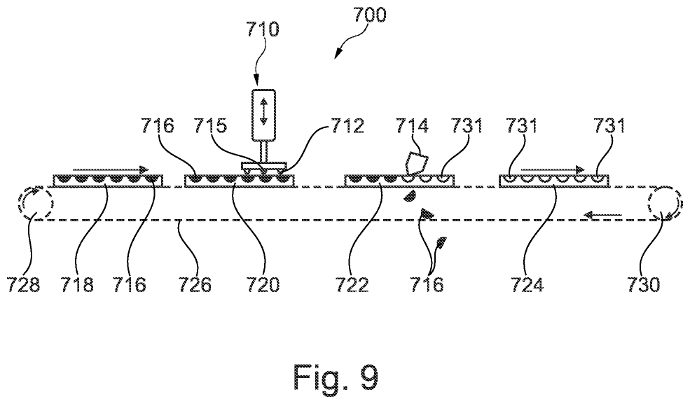

FIG. 9 is a representation of a demoulding apparatus 700 according to an embodiment of the present invention. The demoulding apparatus 700 comprises a dislodging apparatus 710 which comprises a linear mechanical prodder 712 along with an air knife 718 and other components as in FIG. 8.

The demoulding apparatus 700 also comprises a conveyor 726 extending between two rollers 728, 730. The conveyor 726 moves the moulds 718, 720, 722, 724 from left to right.

The dislodging apparatus 710 in FIG. 9 comprises a linear mechanical prodder 712 which comprises a plurality of prodders 715, which simultaneously prod more than one moulded product 716. This results in a very efficient prodding process, which loosens multiple moulded products 716 at once.

The prodders 715 nudge and/or deform the moulded products 716 in the cavities 731. Similar to before, the prodders 715 provide a deformation on the moulded products 716 in cavities 731 in the moulds 718, 720, 722, 724 via any form of movement, disturbing and/or nudging resulting in the breaking of any adhesion point between the moulded products 716 and the cavities 731. It is preferred that there is formed a continuous or substantially continuous lubricant film between the moulded products 716 and the cavity 731.

Also, it may be preferred that the prodders 715 provide an offset prodding action from a central vertical axis of the moulded product 716.

The prodding may occur in a substantially vertical up-and-down manner. Alternatively, the prodding may occur in a direction according to any of the following: about 20-80 degrees from the vertical; about 30-70 degrees the vertical or about 60 degrees from the vertical. The prodding may therefore function as a swiping and/or scooping action on the moulded product 716. The prodding action may be in the form of an actuation through an arc.

The linear mechanical product 712 and the prodders 715 therefore break any form of connection or adhesion point between the moulded products 716 and the cavities 731 in the moulds 718, 720, 722, 724. The air knife 714 then has a much higher success rate of removing the moulded products 716 from the moulds 718, 720, 722, 724. The moulded products 716 can be seen falling from the mould 722, underneath the air knife 714.

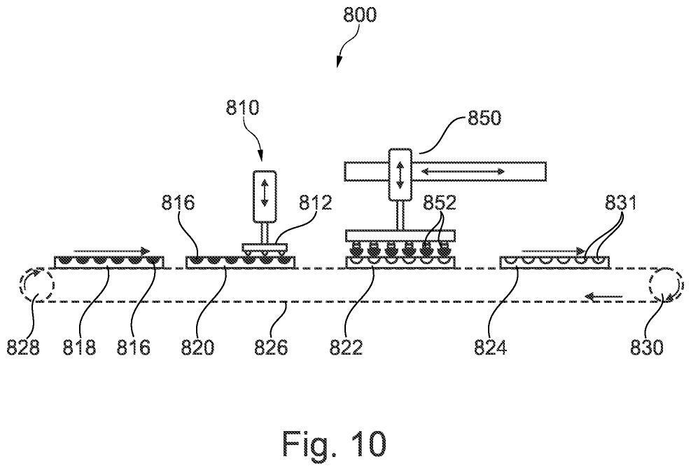

FIG. 10 is a representation of a demoulding apparatus 800 according to an embodiment of the present invention. The demoulding apparatus 800 comprises a dislodging apparatus 810 which comprises a linear mechanical prodder 812 as described in FIG. 9 along with vacuum demoulder removal unit 850.

The demoulding apparatus 800 also comprises a conveyor 826 extending between two rollers 828, 830. The conveyor 826 moves the moulds 818, 820, 822, 824 from left to right.

The dislodging apparatus 810 in FIG. 10 as mentioned comprises both a linear mechanical prodder 812 and a vacuum demoulder removal unit 850.

Similar to before, the linear mechanical prodder 812 provides a deformation on the moulded products 816 in cavities 831 in the moulds 818, 820, 822, 824 via any form of movement, disturbing and/or nudging resulting in the breaking of any adhesion point between the moulded product 816 and the cavities 831. It is preferred that there is formed a continuous or substantially continuous lubricant film between the moulded product 816 and the cavity 831.

Also, it may be preferred that the linear mechanical product 812 may provide a prodding action offset from a central the vertical axis of the moulded product 816.

The prodding may occur in a substantially vertical up-and-down manner. Alternatively, the prodding may occur in a direction according to any of the following: about 20-80 degrees from the vertical; about 30-70 degrees the vertical or about 60 degrees from the vertical. The prodding may therefore function as a swiping and/or scooping action on the moulded product 816. The prodding action may be in the form of an actuation through an arc. e prodding therefore breaks any form of connection or adhesion point between the moulded products 816 and the cavities 831 in the moulds 818, 820, 822, 824. The vacuum demoulder removal unit 850 therefore has a much higher success rate of removing the moulded products 816 from the moulds 818, 820, 822, 824.

The difference between the embodiment shown in FIG. 10 and the embodiment shown in FIG. 9, is that the moulded products 816 are removed from the moulds 818, 820, 822, 824 via a vacuum demoulder removal unit 850.

They vacuum demoulder removal unit 850 comprises a series of suction pads 852 which suck the moulded products 816 from the moulds 818, 820, 822, 824 and thereby removes the moulded products 816 in a more controlled manner.

It should be appreciated that the above Figures are shown in a two-dimensional view. However, the moulds used may be several moulded products deep. For example, in FIG. 10, there are six moulded products 816 shown in each mould 818, 820, 822, 824. However, there may, for example, be twenty lines of moulded products in each row, resulting in 120 moulded products per mould 818, 820, 822, 824.

The above embodiments in FIGS. 6 to 10 should also be seen as mere examples of the present invention in use, and not be seen to be limiting. For example, the dislodging apparatus of the present invention may be combined with any technique and apparatus for removing the moulded products from the moulds. The air knife has been shown only as an example, since it is one of the most popular ways of ejecting moulded products from moulds.

Furthermore, there may be a plurality of dislodging apparatus located in series in, for example, a continuous process, to ensure the moulded products are fully dislodged from the moulds prior to removal and/or ejection.

Whilst specific embodiments of the present invention have been described above, it will be appreciated that departures from the described embodiments may still fall within the scope of the present invention.

1-49. (canceled)

50. An automated dislodging apparatus for deforming a plurality of moulded products with a soft and elastic consistency within mould cavities in an automated production process, the dislodging apparatus comprising:
a non-manual prodder which is capable of deforming a plurality of moulded products held within the mould cavities in a mould;
wherein on deformation the moulded products are deformed such that adhesion of the moulded products to the mould cavities is removed or substantially removed, the moulded products remaining substantially within the cavities after deformation;
thereby preparing the moulded products to be ejected and/or removed from the mould.

51. The dislodging apparatus according to claim 50, wherein the prodder is a non-contact prodder.

52. The dislodging apparatus according to claim 51, wherein the non-contact prodder is a pneumatic flow jet of gas and/or air which deforms moulded products.

53. The dislodging apparatus according to claim 50, wherein the prodder is a contact prodder.

54. The dislodging apparatus according to claim 53, wherein the contact prodder is a mechanical prodding device which deforms moulded products.

55. The dislodging apparatus according to claim 54, wherein the contact prodder is a mechanical linear prodder which moves in a linear fashion to deform moulded products.

56. The dislodging apparatus according to claim 55, wherein the mechanical prodding device is a mechanical rotary prodder which moves in a rotary fashion to deform moulded products.

57. The dislodging apparatus according to claim 54, wherein a tip of the prodder which is intended to contact the moulded products is generally blunt, to avoid damaging the moulded products during contact.

58. The dislodging apparatus according to claim 50, wherein the prodder is capable of deforming a plurality of moulded products simultaneously or sequentially.

59. The dislodging apparatus according to claim 50, wherein the prodder is capable of deforming and disturbing the moulded products in an elastic manner, thereby allowing the moulded products to return to its original shape after the prodding.

60. The dislodging apparatus according to claim 50, wherein the moulded products comprise a centreline vertical axis, running substantially vertically through the moulded products, and wherein the prodder prods the moulded products at a location offset from the centreline vertical axis, or wherein the prodder prods the moulded products at a location substantially in line with the centreline vertical axis.

61. The dislodging apparatus according to claim 50, wherein the moulded products comprise a centreline vertical axis, running substantially vertically through the moulded products, and wherein the prodder prods the moulded products at a direction according to any of the following: about 20-80 degrees from the vertical; about 30-70 degrees the vertical; or about 60 degrees from the vertical.

62. The demoulding apparatus according to claim 50, the demoulding apparatus comprising:
a conveyor system for moving moulds along the demoulding apparatus;
wherein the moulded products remain substantially within the cavities after deformation; and
an ejection device capable of removing the moulded products from the mould cavity in the moulds.

63. The demoulding apparatus according to claim 62, wherein the ejection device is a pneumatic gas knife, which removes the moulded products from the cavity of the mould via a high velocity jet of gas and/or air, or wherein the ejection device is a vacuum device, which removes the moulded products from the cavity of the mould via suction.

64. The demoulding apparatus according to claim 50, wherein the demoulding apparatus further comprises a depositing device which deposits and/or applies a lubricating fluid to mould cavities prior to formation of the moulded products.

65. A method of automatically dislodging a plurality of moulded products with a soft and elastic consistency, the products being within mould cavities in an automated production process, the method comprising the steps of: using a non-manual prodder to deform the moulded products held within the mould cavities, whereby on deformation, the moulded products are deformed such that adhesion of the moulded products to the mould cavities is removed or substantially removed, wherein the moulded products remains substantially within the cavities after deformation; and then ejecting the moulded products from the mould cavities.

66. The method according to claim 65, wherein the moulded product is: a jelly-type product; a food product; a medicinal product.

67. The method according to claim 65, wherein a layer of lubricating fluid is applied between the moulded product and the cavity of the mould.

68. The method according to claim 65, in which the process occurs at multiple moulded products simultaneously.

69. An automated dislodging apparatus for deforming a moulded product with a soft and elastic consistency within a mould cavity in a production process, the dislodging apparatus comprising:
a non-manual prodder which is capable of deforming the moulded product which is held within the mould cavity in a mould, in which the prodder prods the moulded product at a location away from the periphery of the mould cavity;
wherein on deformation the moulded product is deformed such that adhesion of the moulded product to the mould cavity is removed or substantially removed, the moulded product remaining substantially within the cavity after deformation;
thereby preparing the moulded product to be ejected and/or removed from the mould.
